(19) United States
(12) Patent Application Publication
(10) Pub. No.: US 2009/0320344 A1
(43) Pub. Date: Dec. 31, 2009

(54) PRICE CHANNEL EXTRUSION WITH SIGN HOLDING GRIP

(75) Inventors: Patrick J. Barkdoll, Pecatonica, IL (US); Stanley C. Valiulis, Rockford, IL (US); Nicholas C. Juric, Winnebago, IL (US); Todd C. Westberg, Cherry Valley, IL (US)

Correspondence Address: REINHART BOERNER VAN DEUREN P.C., 2215 PERRYGREEN WAY, ROCKFORD, IL, 61107, US

(73) Assignee: SOUTHERN IMPERIAL, INC., Rockford, IL (US)

(21) Appl. No.: 12/551,942

(22) Filed: Sep. 1, 2009

Related U.S. Application Data
(63) Continuation-in-part of application No. 11/403,428, filed on Apr. 13, 2006.

(51) Int. Cl. G09F 3/20

(52) U.S. Cl. 40/661.03

(57) ABSTRACT

A label holder for a retail display apparatus is provided. The label holder comprises a front panel, a sign clip, and a mounting structure for securing the label holder to the retail display apparatus. The sign clip includes a leg portion, including a gripping surface, and resiliently biases to secure a sign between the gripping surface and the front panel. In one embodiment, defined in the front panel are two sign engagement projections that interleavingly interact with the gripping surface. The sign clip is integrally connected to the front panel via an integral hinge and pivots relative to the front panel through the integral hinge between a normal state and a biased state. In the normal state, the leg portion of the clip is positioned proximate the front panel. In the biased state, the leg portion is spaced apart from the front panel and holds a secondary sign therebetween.

### CROSS-REFERENCE TO RELATED PATENT APPLICATIONS

This patent application is a continuation-in-part of co-pending U.S. patent application Ser. No. 11/403,428, filed Apr. 13, 2006, the entire teachings and disclosure of which are incorporated herein by reference thereto.

### FIELD OF THE INVENTION

This invention generally relates to the field of label holders for merchandise displays, and in particular, to label holders for mounting onto a shelf, basket, sign holder, or other device of a retail display.

### BACKGROUND OF THE INVENTION

The present invention is related to price channel label holders that can be extruded of plastic with a clear front panel that forms, in combination with a back panel or the front face of a shelf, a cavity for retaining paper labels therebetween. These label holders have removed the need for adhesive backed labels or labels of flexible plastics, as well as highly-durable labels because paper labels can be placed within the pocket and are protected by the clear front panel.

These label holders can either snap to a structure of the merchandise display such as a shelf or be attached with an adhesive strip. These label holders have greatly reduced the cost in producing labels because the labels are less susceptible to damage and can be made from lower quality material.

However, on occasion, retail products may go on sale or there may be a need to point out a unique or new feature of a product. Such occasions may require a new temporary label or a product description sign to be displayed. This new information may only be displayed for a short period of time making it impractical to place it behind the front panel. Alternatively, the additional information may be displayed on a sign having dimensions that are too large to fit within the main cavity provided by the label holder. Previous label holders have attempted to solve this problem by providing a secondary label clip for holding the additional labels, for example U.S. Pat. Nos. 6,266,906 and 6,708,436 to Nagel. Unfortunately, these label holders require a second softer material for gripping the additional label. This softer material must be co-extruded with the rest of the clip causing the extrusion process to be complex and requiring an additional extrusion screw head.

Thus, there is a need in the art for providing a label holder that functions as a standard label holder as well as more easily and more reliably holds additional labels or signs, while being more easily and efficiently manufactured.

### BRIEF SUMMARY OF THE INVENTION

The invention is directed towards a label holder with an integral secondary sign retainer clip. In one embodiment the label holder includes a front panel coupled to a sign clip by at least one integral hinge. The sign clip also includes at least one second integral hinge coupled to the first integral hinge and a leg portion coupled to the second integral hinge. Defined in the front panel is at least one sign engagement projection. The clip and front panel are designed to retain a sign therebetween, with the clip providing a biasing force toward the front panel. The sign clip also includes a mount structure connected to the front panel and adapted to mount the front panel on a separate support structure of the merchandise display which may be, for example, a shelf, a plastic basket, a wire rod of a wire panel, a wire basket, a display hook, peg hook, a display hook having a scan plate, or other structure of the merchandise display.

Another aspect or feature of the present invention is that such a secondary sign retainer clip of a label holder may consist of plastic, and moreover may consist of the same plastic material throughout, such that extrusion and manufacture of the label holder is relatively simple.

In another embodiment the label holder includes a front panel of a plastic material. The front panel has a front surface. The label holder includes a clip integrally connected to the front panel by a first integral hinge. The clip is pivotable relative to the front panel through the first integral hinge. The clip includes a second integral hinge disposed between the first integral hinge and a leg portion extending upwardly from the second integral hinge. The leg portion includes a gripping surface that faces the front panel. The clip and front panel may consist of a single material of a constant hardness characteristic.

In one embodiment a label holder includes a pair of axially spaced apart sign engagement projections forming a gripping surface receiving cavity, with the gripping surface being positioned between the front surface and the distal portion of each of the axially spaced apart sign engagement portions.

In another embodiment a label holder including a front panel formed from a plastic material with a front surface is provided. A clip is integrally connected to the front panel through a first integral hinge. A sign engagement arrangement formed by a gripping surface of the clip and the front surface is also provided for holding a secondary sign therebetween. The sign engagement arrangement includes a first sign gripping projection positioned to apply a first biasing force to a sign at a first axial location in a first direction, and a second sign gripping projection being positioned to apply a second force in a second axial location, offset from the first axial location, in a second direction opposite the first direction. The sign engagement arrangement is configured such a bending torque is imparted on a portion of the sign by the first and second sign gripping portions. In one embodiment the clip and the front panel consist of a single material of a constant hardness characteristic.

Other aspects, objectives, and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is a side view of a label holder installed on a shelf structure having the label holder and the sign clip in a biased state with a main label positioned behind a front panel and a secondary sign secured by the sign clip in accordance with an embodiment of the present invention;

FIG. 2 is an other side view of the label holder of FIG. 1 wherein the label holder is free of signs and labels;

FIG. 3 is an enlarged partial illustration of the sign clip of FIG. 2;

FIG. 4 is a perspective view of the label holder of FIG. 1;

FIG. 5 is a side view of a label holder installed on a support structure in the form of a shelf structure shown in a biased state in accordance with another embodiment of the present invention;

FIG. 6 is a side view of the label holder of FIG. 5 shown with the label holder free of signs and labels;

FIG. 7 is a side view of a label holder installed on a shelf structure shown in a biased state in accordance with another embodiment of the present invention;

FIG. 8 is a side view of the label holder of FIG. 7 shown with the label holder free of signs and labels;

FIG. 9 is a side view of a label holder installed on a shelf structure shown in a biased state in accordance with another embodiment of the present invention;

FIG. 10 is a side view of the label holder of FIG. 9 shown with the label holder free of signs and labels.

FIG. 11 is a perspective view of another embodiment of a label holder including two sign engagement projections;

FIG. 12 is a side view of the label holder of FIG. 11 having a secondary sign composed of relatively light stock secured by the sign clip;

FIG. 13 is a side view of the label holder of FIG. 11 having the label holder in an unbiased state and the sign clip in a biased state with a secondary sign composed of relatively heavy stock secured by the sign clip;

FIG. 14 is a side view of the label holder of FIG. 11 having the label holder and the sign clip in an unbiased state;

FIG. 15 is a close-up view of the sign clip of FIG. 14 in an unbiased state;

FIG. 16 is a close-up view of an embodiment of a sign clip as a secondary sign is inserted into the sign clip;

FIG. 17 is a close-up view of an embodiment of a sign clip as a secondary sign is removed from the sign clip; and

FIG. 18 is a side view of a label holder including one sign engagement projection in accordance with another embodiment of the present invention.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

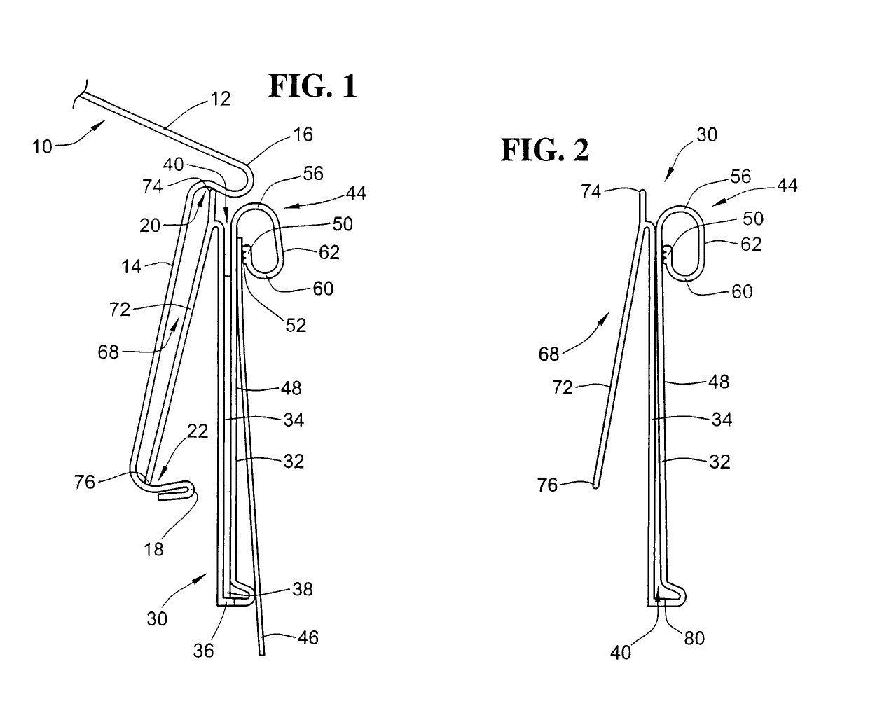

Referring now to the figures, FIG. 1 illustrates a typical “C-channel” shelf structure 10 having a top surface 12, a front panel 14, a top retainer portion 16 and a bottom retainer portion 18. The front panel 14 extends vertically between the top retainer portion 16 and the bottom retainer portion 18 to form a “C-channel” structure to which signs and sign holders can be snapped into and out of. Specifically, the top retainer portion 16 and front panel 14 form an upper pocket channel 20 therebetween. Similarly, the bottom retainer portion 18 and the front panel 14 form a lower pocket 22 therebetween. Respective opposing edges of sign or sign holder can be releasably snapped into the pockets 20, 22 to temporarily secure a sign or sign holder. The top shelf surface 12 can be structured to hold products such as would be appropriate for retail display. Furthermore, the top shelf surface 12 may be horizontal or slanted downward depending on the application. Typically, the shelf structure 10 will be formed from a metal, but can be formed of other materials.

While numerous embodiments of the present invention will be described in concert with a shelf, other embodiments may be configured to be attached other structures of a merchandise display other than a shelf such as, but not limited to, a plastic basket, a wire rod of a wire panel, a wire basket, a peg hook, a display hook, a display hook having a scan plate, or other structure of the merchandise display.

Also shown in FIG. 1 is a label holder, generally designated by reference number 30. The label holder 30 is preferably extruded from a plastic material, such as polyvinyl chloride, Butryrate, Provista, or acrylonitrile butadiene styrene (ABS). The label holder 30 includes a front panel 32 and a back panel 34 that are joined at the bottom 36 of the label holder 30 at intersection 80 in FIG. 2. In this embodiment, the front panel 32 would be translucent and the back panel 34 could be opaque or translucent. The material of the label holder 30 allows the front and back panels 32, 34 to flex relative to one another. As shown in FIG. 1, the label holder 30 can hold a label 38 between the front panel 32 and the back panel 34. Specifically, the label 38 biases the front panel 32 forward and away from the back panel 34 to open and close a cavity 40 formed between the front and back panels 32, 34. This cavity 40 can be used for holding the label 38 therebetween. In an embodiment, the front panel 32 tapers relative to the back panel 34 when no label is positioned therebetween. In a preferred embodiment the taper is approximately between 1 degree and 5 degrees.

The label holder 30 further includes a secondary sign clip 44 for holding a secondary sign 46. The secondary sign 46 may be any label, placard, sign, index card, flyer or other paper-like means for displaying information. The sign clip 44 pinches the secondary sign 46 between the front surface 48 of the front panel 32 and a terminating leg portion 50 of the sign clip 44. As such, the sign clip 44 secures the secondary sign 46 in a location forward of the front panel 32. This position makes attaching and removing the secondary sign 46 quick and easy. Additionally, this position makes the secondary sign 46 stand out from the rest of the display drawing consumer's attention.

With reference to FIGS. 1-3, in the illustrated embodiment, the terminating leg portion 50 of the clip includes a gripping surface that may include a plurality of ribs 52 extending rearwards toward the front panel 32. The ribs focus the impact force to help grip and engage the secondary sign 46. The ribs 52 extend the horizontal length of the label holder 30. The ribs 52 have a varying profile such that the ribs become narrower toward the rib tips 53. It will be appreciated that the leg portion 50 is not limited to having three ribs 52, but may have more or less than three ribs 52 and may even have no ribs at all.

The sign clip 44 is movable between a normal state (see FIG. 2) and extended biased state (see FIG. 1) via a first integral hinge 56. The first integral hinge 56 secures the sign clip 44 to a top portion of the front panel 32 and allows the sign clip 44 to pivot relative to the front panel 32 when a secondary sign 46 is inserted between the leg portion 50 and the front panel 32. In the biased state, the leg portion 50 of the sign clip 44 is spaced apart from the front surface 48. During the normal state, when no sign is present, the leg portion 50 is proximate the front surface 48. In an embodiment, the leg portion 50, particularly the rib tips 53 of the plurality of ribs 52, touch the front surface 48 in the normal state. In an embodiment, in the normal state, the sign clip 44 is urged against the front surface and the resiliency in the sign clip 44 positively spring loads the leg portion 50 against the front surface 48. As is shown, the location where the leg portion 50 presses against the front surface 48 is substantially planar and free of any ribs.

The first integral hinge 56 is connected to the top of the front panel 32 and extends forwardly therefrom to form a generally U-shaped top portion of the clip. In the illustrated embodiment, the sign clip 44 also includes a second integral hinge 60 between the first integral hinge 56 and the terminating leg portion 50. This bottom hinge 60 forms a generally U-shaped lower portion of the clip. The terminating leg portion 50 extends vertically upward from the second integral hinge 60 and terminates in a free end. As such, the second integral hinge 60 forms the bottommost portion of the sign clip 44.

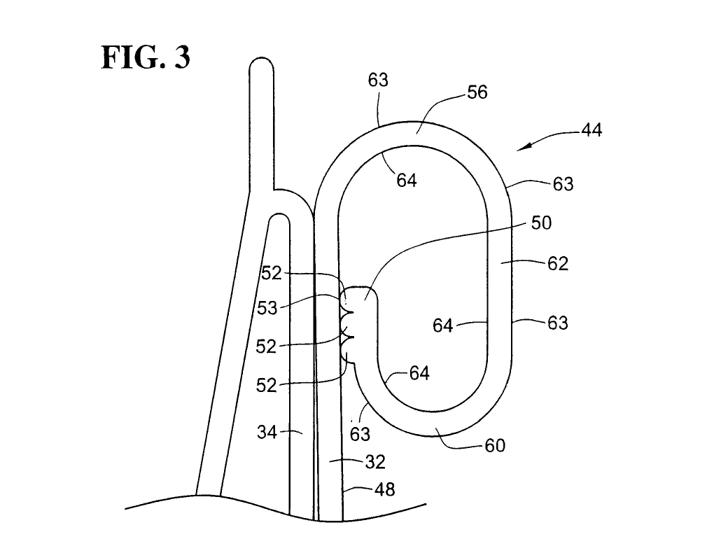

As is shown in FIGS. 2 and 3, the first and second integral hinges 56, 60 give the sign clip 44 a substantially oval cross-section in the normal state. The first and second integral hinges 56, 60 are substantially semi-circular and connected by a straight generally vertical, extension portion 62. The semi-circular outer surface of the second integral hinge provides a guide for inserting and directing signs 46 into the clip 44. The leg portion 50, the second integral hinge 60 and the extension portion 62 form the U-shaped profile. Furthermore, the second integral hinge 60 extends rearward from the extension portion 62 such that the second integral hinge 60 is positioned below and/or curled under the first integral hinge 56. As such, the diameter of the first integral hinge 56 is larger than the second integral hinge 60. However, it will be appreciated that the sign clip 44, through the U-shapes of the first and second integral hinges 56, 60, can approximate other shapes such as an ellipse, a circle, a rectangle, or other loop like shapes, all of which are meant to be encompassed by “generally U-shaped.” In the normal state, the leg portion 50 is preferably substantially parallel to the front panel 32 and the extension portion 62. By “substantially parallel,” it is meant that the leg portion 50 is canted at no more than about 20 degrees relative to the front panel 32 and more preferably no more than about 10 degrees.

As shown in FIG. 3, the curled or looped shape of the sign clip 44 provides that the exterior surface 63 of the sign clip 44 merges into the back surface of the front panel 32. Furthermore, an interior surface 64 of the sign clip 44 merges into the front surface 48 of the front panel 32. The exterior surface 63 and interior surface 64 of the sign clip 44 meet at the terminating vertical end of the leg portion 50.

With reference to FIGS. 1 and 2, the label holder 30 includes a mounting structure, illustrated in the form of shelf mount 68 for securing the label holder 30 to a structure of the merchandise display illustrated as shelf structure 10. Other, mounting structures or arrangements can be provided such that the label holder 30 could be mounted to other structures of a merchandise display. The shelf mount 68 extends rearward from the back panel 34. In this embodiment, the back panel 34 is interposed between the front panel 32 and the shelf mount 68 and connects the front panel 32 to the shelf mount 68. The shelf mount 68 includes a resiliently flexible mounting strip 72 that extends between first and second distal ends 74, 76. The distal ends 74, 76 of the mounting strip 72 insert into the top and bottom label holder pockets 20, 22, respectively, to secure the label holder 30 to the shelf structure 10. Specifically, while attaching the label holder 30 to the shelf structure 10, either the first distal end 74 or the second distal end 76 is inserted into the corresponding top or bottom label holder channel 20, 22. Then, the mounting strip 72 is resiliently flexed and the other distal end is inserted into the other corresponding label holder channel. In this embodiment, the distance between the distal ends 74, 76 of the mounting strip 72 is proportionately larger than the distance between the two label holder channels 20, 22 of the shelf structure 10 such that when the mounting strip 72 is inserted therein a pressure fit is established, i.e. the mounting strip 72 is in a flexed condition while mounted to the shelf structure 10.

In this embodiment the entire label holder 30 can be extruded by a single screw head into a unitary body of entirely the same material having the same characteristics and properties. In this embodiment, the entire label holder 30 would be preferably made from a translucent material such that labels 38 secured in cavity 40 may be displayed. In an alternative embodiment, the back panel 34 and shelf mount 68 are extruded from a first material and the front panel 32 and the sign clip 44 are extruded from a second material. This embodiment requires the use of two extension screw heads for extruding, one screw head for each material. In this embodiment, the first and second materials are co-extruded and the two bodies are connected at intersection 80. This embodiment is beneficial when it is desired to have the back panel 34 colored while keeping the front panel 32 and sign clip 44 translucent.

During extrusion, the label holder exits the extrusion die with the leg portion 50 spaced away from the front surface 48 of the front panel 32. However, as indicated previously, in an embodiment, the gripping surface of the leg portion 50 is proximate the front panel 32 and in a preferred embodiment the leg portion 50 may touch and be urged against the front surface 48 of the front panel 32 in the normal state. After exiting the extrusion die, the extruded label holder is passed through a calibration die that presses the sign clip 44 toward the front panel 48 to appropriately position the leg portion 50 relative to the front panel 32. Specifically, the clip 44 is urged towards and/or against the front panel 32 closing the gap therebetween.

A further benefit of the sign clip 44 is that the sign clip 44 simplifies replacing the label 38 stored in the cavity 40. The sign clip 44 provides a handle for a user to grasp and pull to more easily spread the front panel 32 from the back panel 34 while removing an old label or adding a new label.

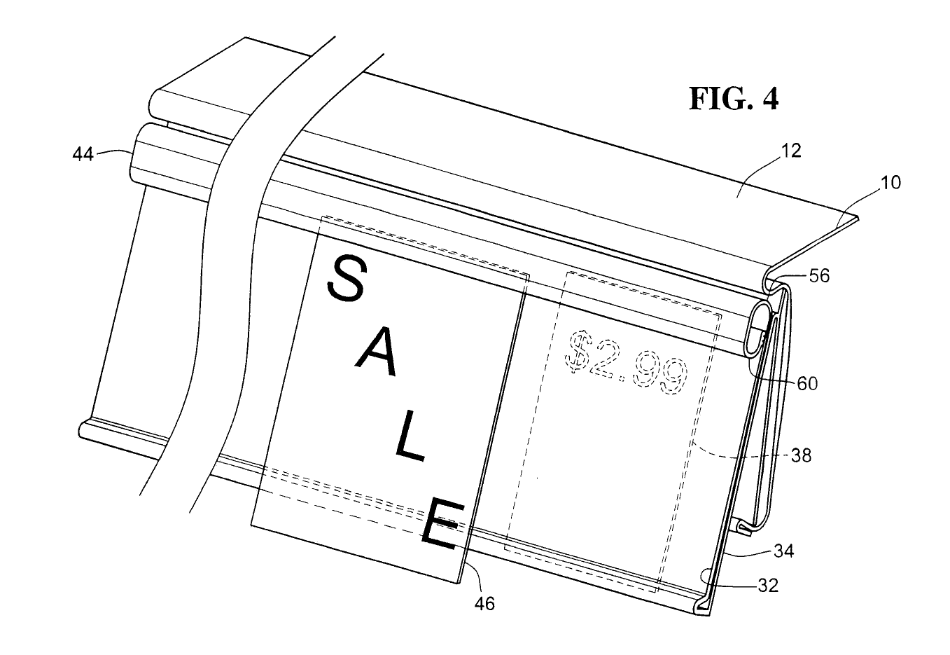

Referring now to FIG. 4, a perspective broken view of the label holder 30 is shown illustrating that the label holder 30 can be of any suitable length appropriate for any length of shelf structure 10. As one skilled in the art will appreciate, the size of the label holder 30 can be adjusted for different sized shelf structures 10. In a typical embodiment, as shown in FIGS. 1 and 4, the label holder 30 does not project above the top panel 12 of the shelf structure 10, thereby enabling customers to easily remove products from the shelf structure 10. With reference to FIGS. 1 and 2, the height of the cavity 40 defined between the front panel 32 and back panel 34 can be adjusted for different sized labels 38. It is a benefit of the featured shelf mount 68 that the cavity 40 is not limited to the height of the front panel 14 of the shelf structure 10. Typically, however, the height of the label holder 30, at least in some embodiments, can be approximately between about 1 ⅛″ and about 1 2″ or between approximately 3″ and 6″.

It is preferable that the height of the sign clip 44 is such that the sign clip 44 does not significantly block or obscure sight of a significant portion of the front panel 32 thereby allowing sufficient visibility of labels 38 inserted into the cavity 40. It is preferable that the height of the sign clip 44 from the top integral hinge 56 to the bottom integral hinge 60 be approximately between about ⅛″ and about ⅜″.

Furthermore, as the thickness of the sign clip 44, particularly the thickness of the first and second integral hinges 56 and 60, affects the gripping strength of the sign clip 44, the sign clip 44 can be configured to hold heavier and/or slicker signs 46 by increasing the thickness of the sign clip 44. In a preferred embodiment, the sign clip 44 and the front panel 32 have a substantially uniform thickness, and the thickness being between about 1/100″ to about 3/100″. The distance that the leg portion 50 is biased away from the front surface 48 also affects the amount of gripping force for a given clip thickness. Thus, if the sign clip 44 is only going to be biased a very small distance, i.e. when holding a very thin secondary sign 46, the clip thickness can be increased to increase the gripping force provided by the smaller biased distance from the front surface 48.

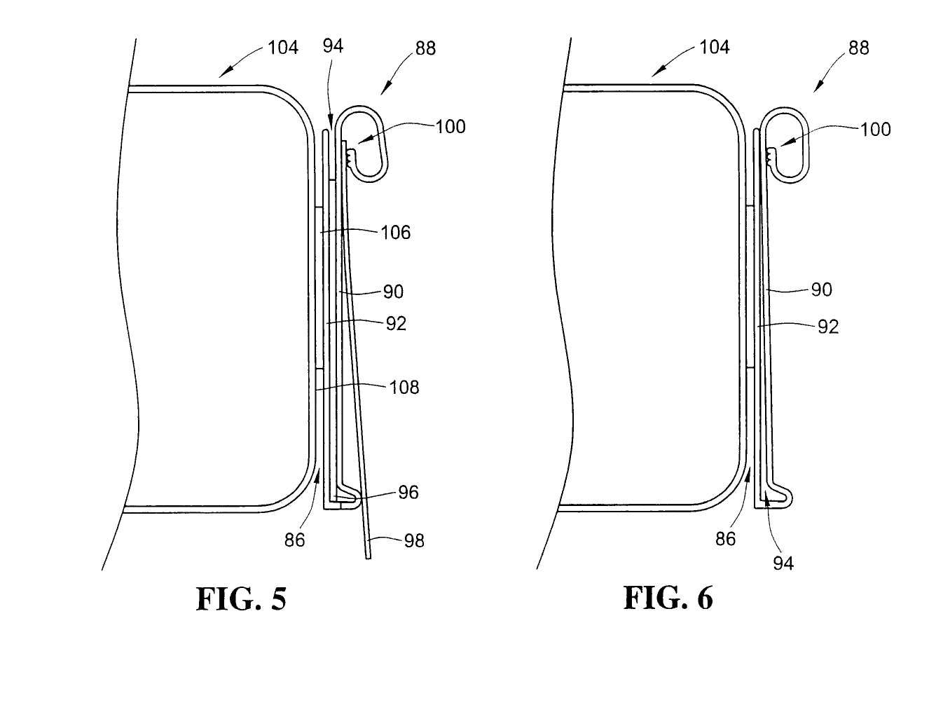

An alternative embodiment of a label holder 86 is illustrated in FIGS. 5 and 6. This embodiment is similar to the previous embodiment in that it includes a sign clip 88, front and back panels 90, 92 that form a cavity 94 therebetween for holding a label 96. The sign clip 88 secures a secondary sign 98 between a leg portion 100 of the sign clip 88 and the front panel 90 as explained previously.

The label holder 86 includes different mounting structure and particularly a different shelf mount structure and is mounted to the shelf structure 104 by adhesive means 106. The adhesive means 106 can be any adhesive means that are sufficiently strong to secure the label holder 86 to the front face 108 of the shelf structure 104. This could be in the form of a liquid adhesive that is spread onto the front face 108 of the shelf structure 104 that secures the label holder 86 to the shelf structure when it sets and/or cures. Alternatively, the adhesive means could be in the form of double sided roll-type adhesive such as what is referred to as double-sided tape.

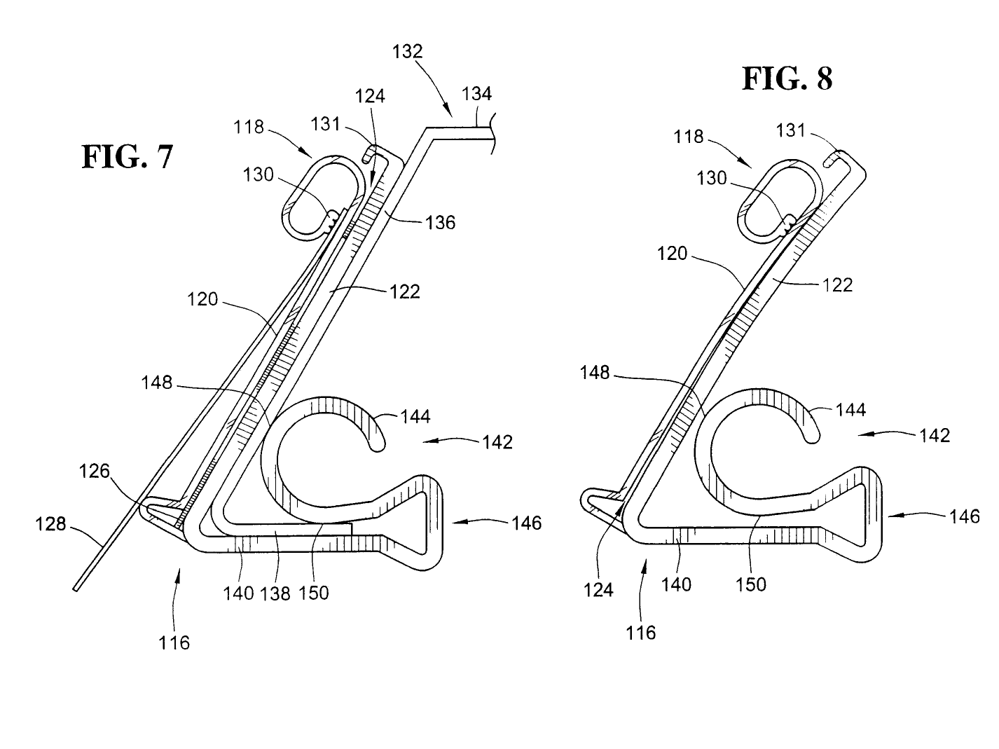

An alternative embodiment of a label holder 116 according to the teachings of the present invention is illustrated in FIGS. 7 and 8. The embodiment is similar to the previous embodiments in that it includes a sign clip 118, a front panel 120 and a back panel 122 that form a cavity 124 therebetween suitable for receiving a label 126. The sign clip 118 secures a secondary sign 128 between a leg portion 130 of the sign clip 118 and the front panel 120 as explained previously.

The label holder 116 further includes a protective flange 131 that is integral with and extends forwardly from the back panel 122 over the front panel 120 and a portion of the sign clip 118. The protective flange 131 helps prevent labels 126 from being erroneously removed from the cavity 124. The sign clip 118 greatly assists a user in inserting and removing the label 126 from the cavity 124 by making it easier to grip and to separate the front panel 120 from the back panel 122. The protective flange 131 could take other shapes or forms such as being just a forward projecting rib.

One type of shelf structure 132 that the label holder 116 may be mounted to includes a top surface 134, a flat angled front panel 136 and a lower support flange 138 and is illustrated in FIG. 6. The shelf structure 132 and similar shelf structures are of the type typically referred to as Darling or Syndicate type flat-faced shelving.

The label holder 116 further includes a flat bottom surface 140 extending rearwardly from the back panel 122. The flat bottom surface 140 is part of a shelf mount 142. The shelf mount 142 also includes a forwardly-facing, spring clip 144 connected to a rearward end 146 with an opening at an end of spring clip 144 that provides resilient clamping onto the shelf structure 132 by two clamp points identified by reference numbers 148 and 150. The area between the back panel 122, bottom surface 140 and spring clip 144 forms a gripping channel including the clamp points 148 and 150, as is best illustrated in FIG. 8.

The embodiment requires the front and back panels 120, 122 to flex from a relaxed state (FIG. 8) to a biased state (FIG. 7) when mounted to the shelf structure 132. In the relaxed state, the front and back panels 120, 122 have a resilient curve. As illustrated in FIG. 7, after mounting to shelf structure 132 the front and back panels 120, 122 are biased such that they are substantially straight and substantially parallel to front panel 136 of the shelf structure 132.

Referring to FIG. 7, to mount the label holder 116 onto shelf structure 132, the spring clip 144 and the back panel 122 resiliently flex around the shelf structure 132 at the lower support flange 138. The shelf mount 142, with the spring clip 144, and the rearward end 146, function as a spring to provide resilient attachment to the shelf structure 132. After attaching the label holder 116 to the shelf structure 132, the label holder 132 grips the angled front panel 136 and lower support flange 138 by having the spring clip 144 grip both the angled front panel 136 and the lower support flange 138 at the same time. When in the fully mounted position, the back panel 122 lies substantially flush with the angled front panel 136; and the flat bottom surface 140 lies substantially flush with the lower support flange 138. During mounting, the shelf mount 142, including the spring clip 144, the bottom surface 140 and the rearward end 146 resiliently extend around the lower support flange 138 of the shelf structure 132 and the flexure of the shelf mount 142 and the front and back panels 120, 122 improve the securement of the label holder 116 to the shelf structure 132.

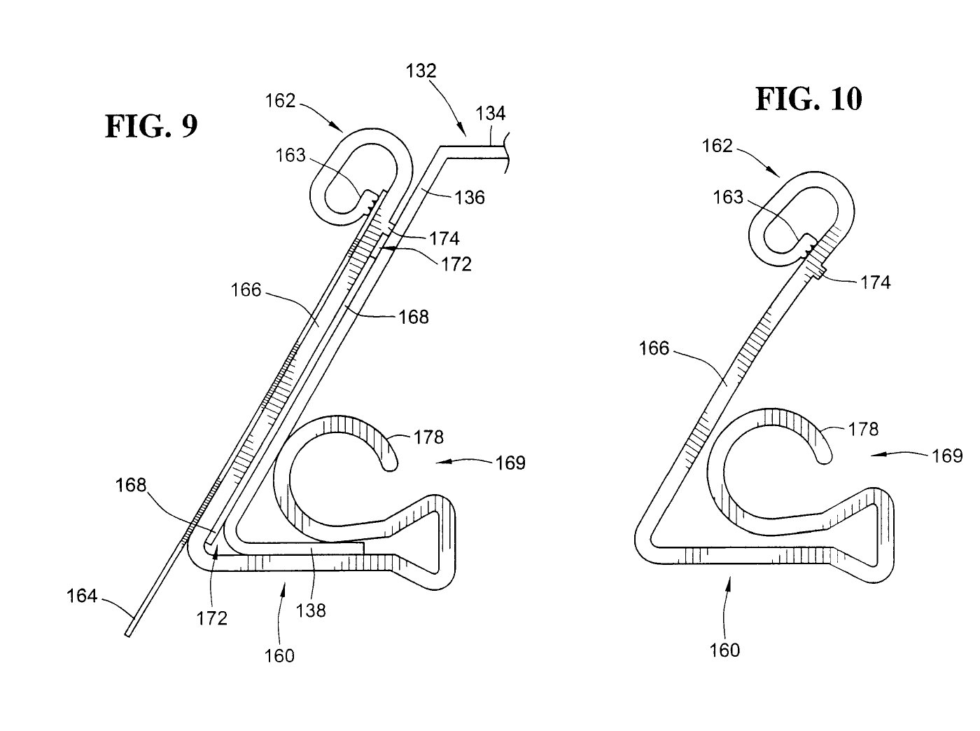

A further alternative embodiment of a label holder 160 in accordance with the teachings of the present invention is illustrated in FIGS. 9 and 10. The label holder 160 is similar to the previous embodiments in that it includes a sign clip 162 having a leg portion 163 for holding a secondary sign 164 between the leg portion 163 and a front panel 166 of the label holder 160. Additionally, the front panel 166 protects a label 168 positioned behind the front panel 166, as illustrated in FIG. 9.

The label holder 160 includes a similar shelf mount 169 and similarly mounts to the same shelf structure 132 as the embodiment illustrated in FIGS. 7 and 8. However, as is shown in FIG. 9, the label holder 160 has only one panel, i.e. front panel 166. The front panel 166 and front panel 136 of the shelf structure 132 create, therebetween, the cavity 172 for holding the label 168. In an embodiment, the label holder 160 optionally includes a rib 174 extending rearward from the front panel 166 and positioned proximate the sign clip 162. The rib 174 extends along an entire lateral span of the label holder 160 and is generally parallel with sign clip 162.

The rib 174 performs several beneficial functions. First, the rib 174 engages the front panel 136 of the shelf structure 132 prior to the rest of the front panel 166. In fact, as shown in FIG. 9, the rib 174 is the only portion of the front panel 166 that contacts the front panel 136. The rib 174 assists in biasing the front panel 166 from a relaxed state (FIG. 10) to a biased state (FIG. 9).

As the transition from the relaxed state to the biased state occurs, the flexure of the front panel 166 from a curved panel (FIG. 10) to generally planar, straight, and/or flat panel (FIG. 9) promotes and/or causes spring clip 178 of the shelf mount 169 to engage with the front panel 136 as shown in FIG. 9. Therefore, in this embodiment, the rib 174 and shelf mount 169 ensure that the spring clip 178 positively and forcibly engages the front panel 136 when the label holder 160 is clamped to a shelf structure 132.

When the label 168 is disposed within the cavity 172, the rib 174 acts as a “lid” and/or “stop” to inhibit and/or prevent the label from being unintentionally removed from the cavity 172. Even so, because the front panel 166 is flexible, if the label 168 needs to be removed, the front panel 166 can simply be biased away from the front panel 136 until the rib 174 and the front panel 136 disengage and form an opening of the cavity 172. The label 168 can then be easily slid and/or pulled upwardly and out of the cavity 172 for removal, replacement, cleaning, repositioning, and the like. Furthermore, the sign clip 162 for holding the sign 164 may function as a handle and allow the user to more easily separate the front panel 166 of the label holder 160 from the shelf structure 132.

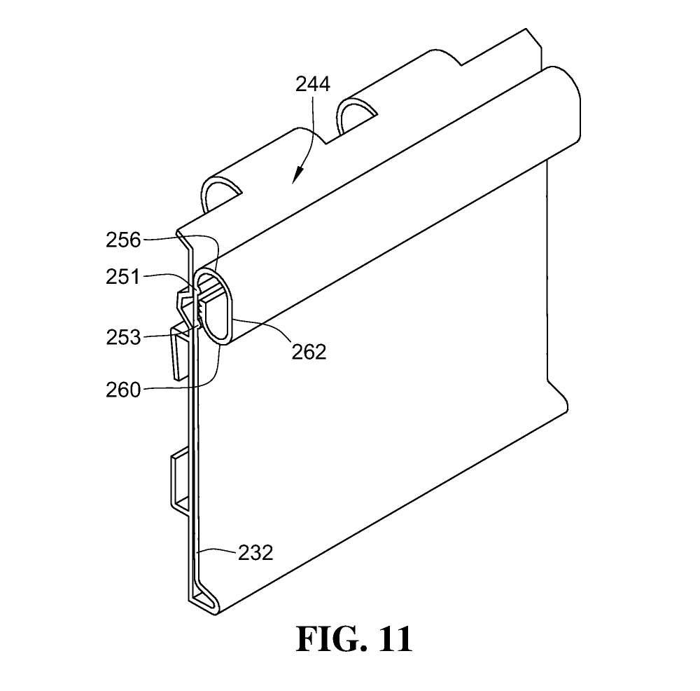

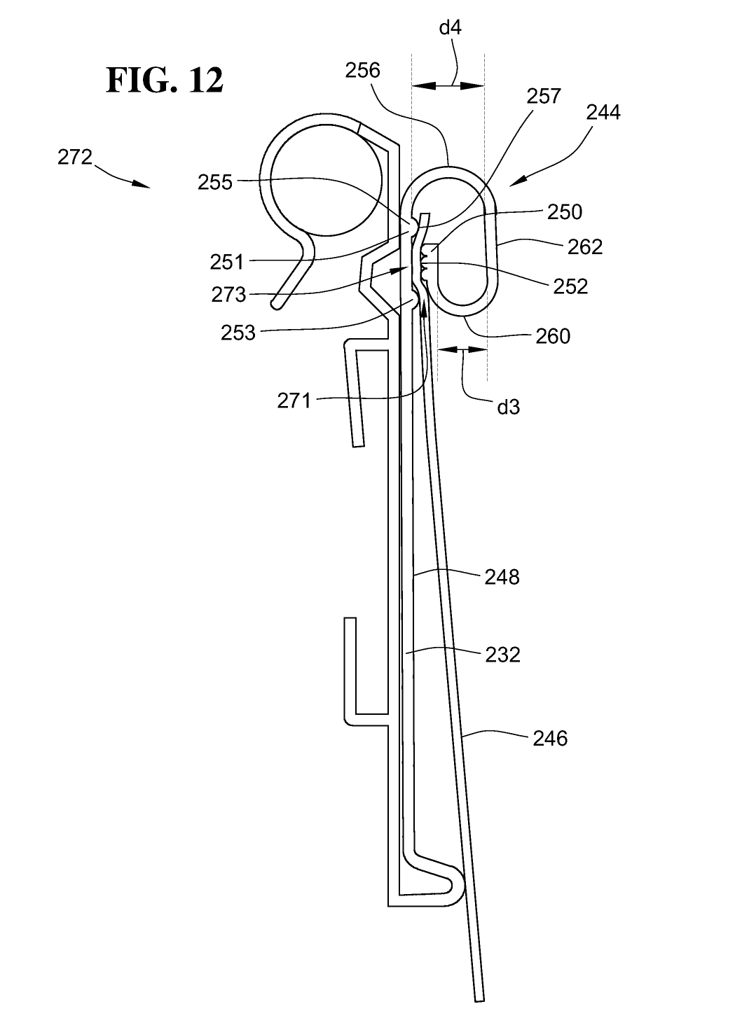

Another embodiment of the present invention is illustrated in FIGS. 11-17. This embodiment comprises many of the same features as the previous embodiments, including a secondary sign clip 244. With primary reference to FIG. 12, the secondary sign clip 244 is again attached to the front panel 232 by a first integral hinge 256. The first integral hinge 256 is connected to the top of the front panel 232 and extends forwardly therefrom to form a generally U-shaped top portion of the secondary sign clip 244. In the illustrated embodiment, the secondary sign clip 244 also includes a second integral hinge 260 between the first integral hinge 256 and the terminating leg portion 250. This second integral hinge 260 forms a generally U-shaped lower portion of the secondary sign clip 244. The terminating leg portion 250 extends vertically upward from the second integral hinge 260 and terminates in a free end. As such, the second integral hinge 260 forms the bottommost portion of the secondary sign clip 244. Again, this embodiment can be configured to include a mounting structure for mounting to various different structures of a merchandise display, including but not limited to, a plastic basket, a peg hook, a wire rod of a wire panel or wire fence, a wire basket, a display hook, a display hook having a scan plate, or other structure of a merchandise display.

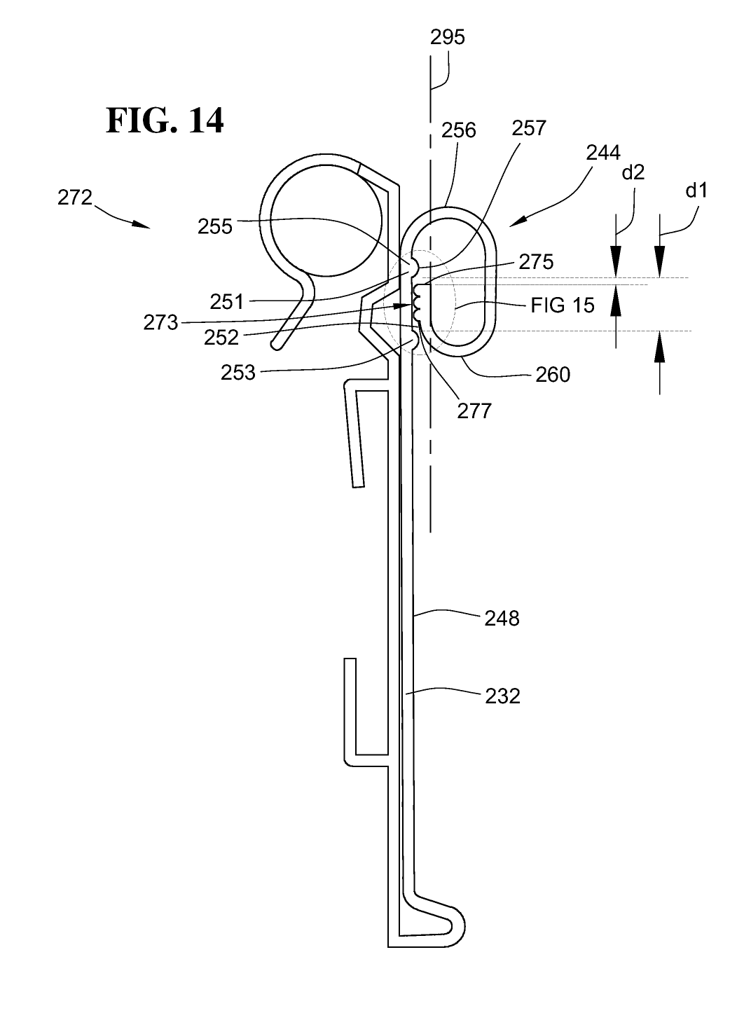

This embodiment differs from previous embodiments in that defined in the front surface 248 of the front panel 232 are a first sign engagement projection 251 and a second sign engagement projection 253 spaced apart an axial distance d₁ along first axis 295 from the first sign engagement projection 251 (see FIG. 14). First axis 295 is substantially parallel to the front panel 232. The two sign engagement projections 251, 253 define a gripping surface receiving cavity 273 spanning the axial distance d₁ between the two sign engagement portions 215, 253. While two sign engagement projections 251, 253 are described with respect to this embodiment of the present invention, other numbers of sign engagement projections are envisioned.

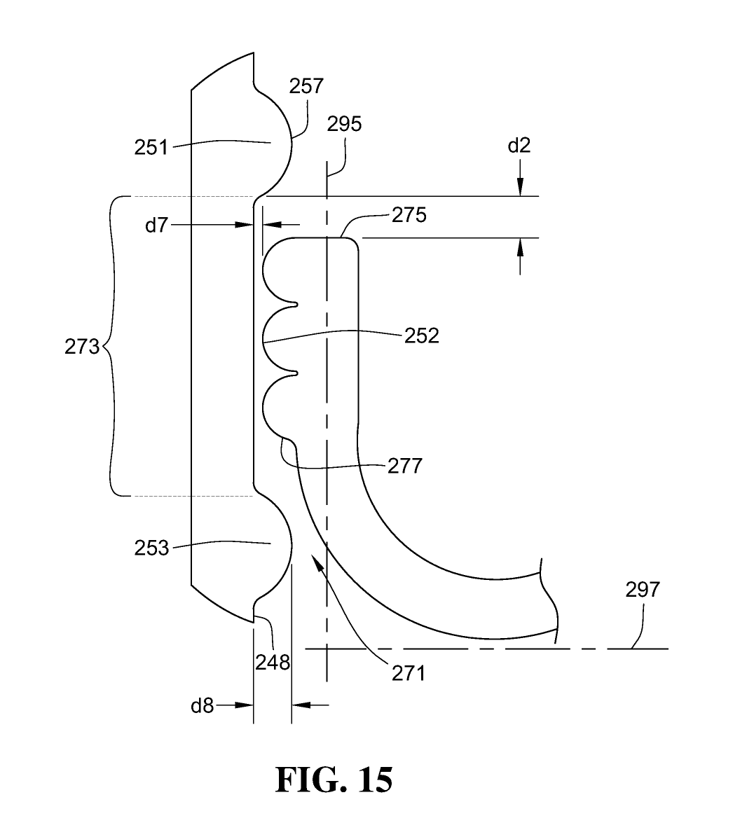

The sign engagement projections 251, 253 project substantially perpendicularly outward from the front surface 248 of the front panel 232 in a generally cantilevered orientation. Sign engagement projection 251 includes a base portion 255 proximate to the front surface 248 and a free end 257 coupled to the base portion 255 and distal from the front surface 248. In the normal state, the gripping surface 252 of the terminating leg portion 250 rests within the gripping surface receiving cavity 273 either proximate to or in contact with the front face 248 of the front surface 232 (see FIG. 15 and further description below). In one embodiment the top edge 275 of the gripping surface 252 of the terminating leg portion 250 is axially offset from sign engagement projection 251 by a distance d₂ along first axis 295 illustrated in FIG. 14. Bottom edge 277 of the gripping surface 252 is also axially offset from the second sign engagement projection 253 along the first axis 295. While the axial offset distances between the edges 275, 277 of the gripping surface 252 and the sign engagement projections 251, 253 are illustrated in FIG. 14 as substantially similar, in other embodiments these axial offset distances may vary considerably, may be different from each other, and may be very small or considerably larger. All that is required in some embodiments is that the distal free ends of projections of the gripping surface extend into cavity 273 and between the distal free ends of sign engagement projections 251, 253.

In FIG. 15, a second axis 297 is defined perpendicular to the front surface 248. The gripping surface 252 is illustrated as axially offset a distance d₇, which distance can vary in different embodiments. The sign engagement projection 253 has an axial height d₈ defined along the second axis 297. In one embodiment the axial height d₈ is greater than the offset distance d₇. This illustrates that the gripping surface 252 is disposed within the cavity 273 formed between the sign engagement projections 251, 253.

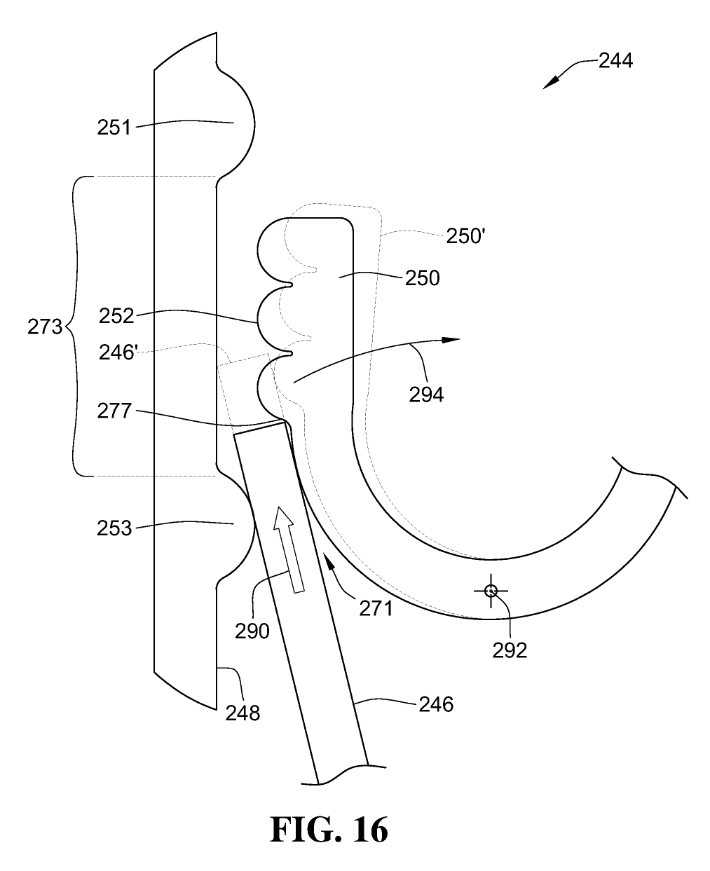

The sign engagement projection 253 and the secondary sign clip 244 further define an insertion mouth 271 (see FIG. 12) between the second integral hinge 260 of the secondary sign clip 244 and the sign engagement projection 253. A secondary sign 246 may be inserted between the secondary sign clip 244 and sign engagement projection 253 through the insertion mouth 271 (see FIG. 16 and further description below). The insertion mouth 271 also acts to guide the secondary sign 246 into the secondary sign clip 244 and properly configure the secondary sign 246 within the secondary sign clip 244.

In one embodiment, the sign engagement projections 251, 253 are formed in the shape of semi-circles of a radius of approximately between 0.3 millimeters and 0.4 millimeters and preferably about 0.33 millimeters projecting outwardly from the front surface 248. In this embodiment the outermost tip of the semi-circle is located approximately between about 0.2 millimeters and 0.3 millimeters and preferably about 0.25 millimeters from the second integral hinge 260, meaning that the insertion mouth 271 has a corresponding width.

In one embodiment, the sign engagement portions 251, 253 are spaced apart an axial distance along the first axis 295 of between about 3 millimeters and 4 millimeters and preferably about 3.6 millimeters along first axis 295, this distance being measured between the centers of each of the semi-circular sign engagement portions 251, 253. This means that the axial width along the first axis 295 of the gripping surface 252 is about 1.50-1.70 millimeters, preferably about 1.66 millimeters in this embodiment to allow the gripping surface 252 to be received into the gripping surface receiving cavity 273 and to be axially offset along the first axis 295 from each of the sign engagement projections 251, 253.

This is merely an exemplary embodiment. Many other shapes, including ovals, ellipses, squares, and triangles, among other shapes, of sign engagement projections 251, 253 are envisioned, along with other dimensional layouts. The sign engagement projections 251, 253 may be spaced axially farther apart or closer together, and the gripping surface 252 may be wider or narrower.

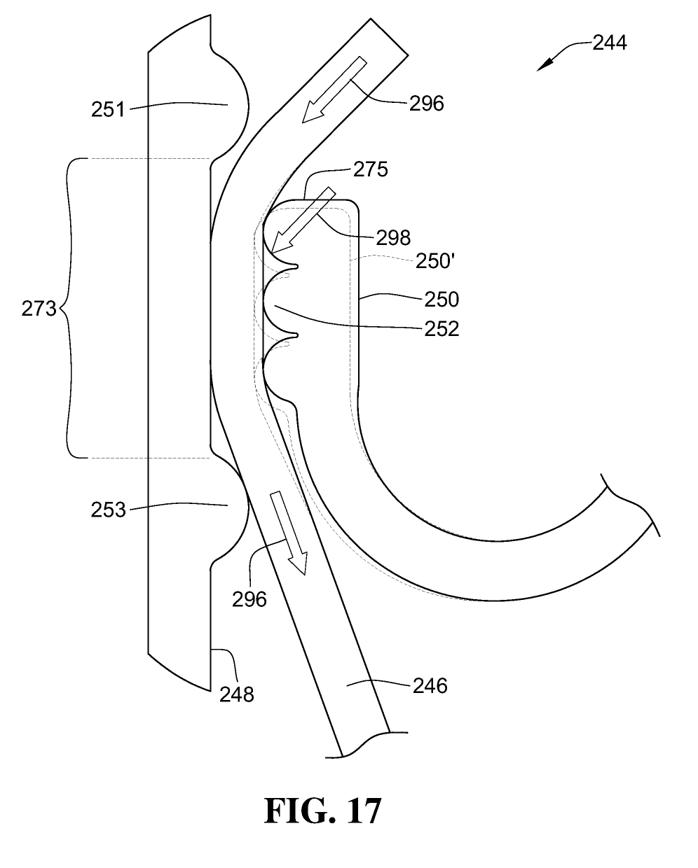

With reference to FIG. 12, the sign clip 244 pinches the secondary sign 246 between the front surface 248 of the front panel 232 and a terminating leg portion 250 of the sign clip 244. As such, the sign clip 244 secures the secondary sign 246 in a location forward of the front panel 232. This position makes attaching the secondary sign 246 quick and easy. Additionally, this position makes the secondary sign 246 stand out from the rest of the display drawing consumer's attention. However, because the secondary sign 246 is made of a lighter, flexible stock, the force created by first integral hinge 256 and second integral hinge 260 biases the gripping surface 252 against the secondary sign 246 and deforms the portion of the secondary sign 246 located axially along first axis 295 between the first sign engagement projection 251 and the second engagement projection 253, forcing this portion of the secondary sign 246 laterally into the gripping surface receiving cavity 273. This is exaggerated in FIG. 12. This creates an interference interaction between the secondary sign 246 and the gripping surface 252 when the sign 246 is pulled (see FIG. 17 and further description below), and sign engagement projections 251, 253, causing the secondary sign 246, because of the bends introduced into the sign 246 by the gripping surface 252 and the sign engagement projections 251, 253, to be more firmly held in place by the secondary sign clip 244.

Also, as in the previous embodiments, during installation of the secondary sign 246 between the secondary sign clip 244 and front panel 232 urges the gripping surface 252 away from the front panel 232, biasing both the first integral hinge 256 and the second integral hinge 260. The distance d₃ between the terminating leg portion 250 and the straight vertical extension portion 262 is decreased when the secondary sign 246 is inserted into the secondary sign clip 244 (FIG. 12) as compared to when the secondary sign clip 244 is in its normal state (FIG. 14). As the distance d₃ decreases, the biasing force toward the front panel 232 provided by the second integral hinge 260 increases.

Also, as in the previous embodiments, the installation of the secondary sign 246 between the secondary sign clip 244 and front panel 232 increases the distance d₄ between the straight vertical extension portion 262 and the front panel 232. Increasing this distance d₄ increases the biasing force provided by the first integral hinge 256 toward the front panel 232, further increasing gripping force by leg portion 250.

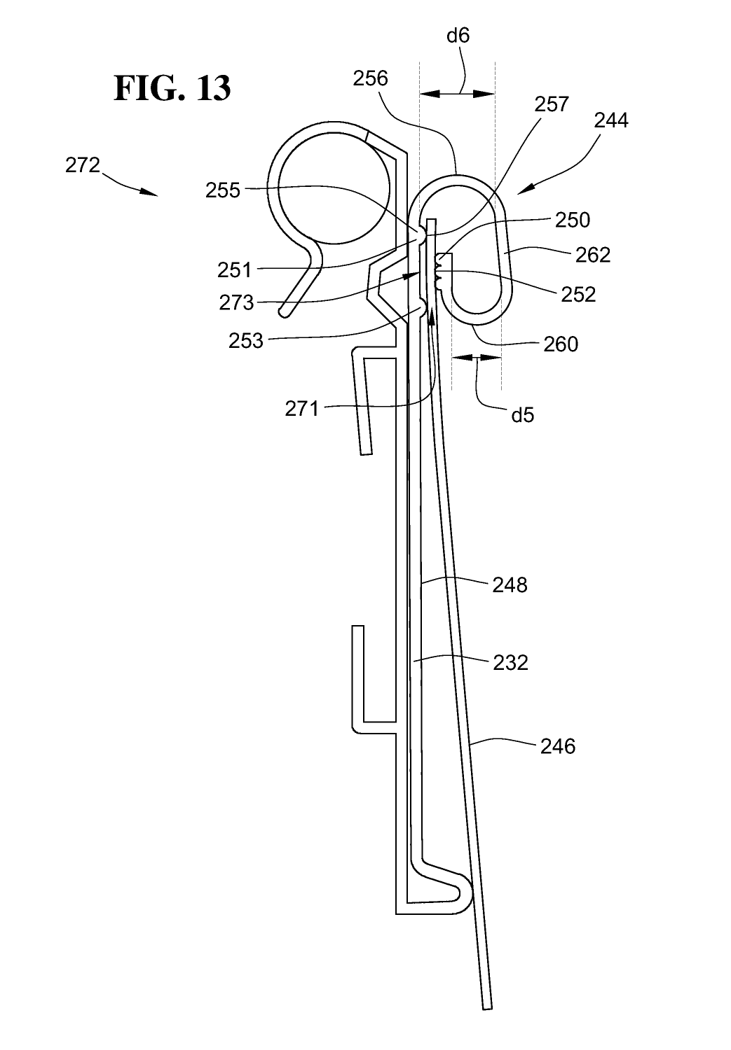

With reference to FIG. 13, a heavier, thicker stock secondary sign 247 may also be used. When the heavier stock secondary sign 247 is inserted into the secondary sign holder 244, because the heavier stock secondary sign 247 is more resistant to the biasing force of the first and second integral hinges 256, 260, the heavier stock secondary sign 247 is deformed less than, if at all, the lighter stock secondary sign 246 of FIG. 12. Therefore, the heavier stock secondary sign 247, while it may still be pushed somewhat into the gripping surface receiving cavity 273, it is not pushed as far into the gripping surface receiving cavity 273, meaning that the interference interaction between the heavier stock secondary sign 247 and the sign engagement projections 251, 253 is reduced, compared to that of the lighter stock secondary sign 246. While decreased interference interaction may provide reduced retention of the heavier stock secondary sign 247; however, because the heavier stock secondary sign 247 is thicker than the lighter stock secondary sign 246, the first and second integral hinges 256, 260 are displaced farther than in the case of the lighter stock secondary sign 246 causing increased biasing forces to be applied by leg portion 250.

With reference to FIG. 13, the distance d₅ between the terminating leg portion 250 and the straight vertical extension portion 262 will not only be less than when the secondary sign clip 244 is in a normal configuration, but also, will typically be less than d₃ of FIG. 12 because the thicker heavier stock secondary sign 247 will compress the second integral hinge 260 more than the thinner lighter stock secondary sign 246 of FIG. 12. Because the second integral hinge 260 is compressed farther, it will inherently produce a greater biasing force toward the front panel 232. This increased biasing force towards the front panel 232 will pinch the thicker heavier stock secondary sign 247 more securely between the gripping surface 252 and the front panel 232, thereby compensating for the reduced interference interaction and firmly retaining the thicker heavier secondary sign 247 within the secondary sign clip 244.

Similarly, the thicker heavier stock secondary sign 247 also displaces the first integral hinge 256 farther than when the secondary sign clip 244 is in a normal state, as well as farther than the thinner lighter stock secondary sign 246. This means that the distance d₆ is greater than the distance d₄ of FIG. 12. Inherently, this means that the first integral hinge 256 will provide a greater biasing force towards the front panel 232. This increased biasing force towards the front panel 232 will again pinch the thicker heavier stock secondary sign 247 more securely between the gripping surface 252 and the front panel 232, thereby compensating for the reduced interference interaction and firmly retaining the thicker heavier secondary sign 247 within the secondary sign clip 244.

Even using the thicker heavier stock secondary sign 247, the secondary sign clip 244 is configured such the secondary sign 247 can be slid into the secondary sign clip 244 easily, but is firmly retained within the secondary sign clip 244 because the biasing force towards the front panel 232 provided by the first and second integral hinges 256, 260 of the secondary sign clip 244 increases as d₅ is decreased and d₆ is increased.

FIG. 16 schematically illustrates in exaggerated form one process of inserting a secondary sign 246 into one embodiment of the secondary sign clip 244 and the forces and motion resultant from this process. The secondary sign 246 is provided with a force in the direction of arrow 290. The secondary sign 246 contacts the bottom edge 277 of the gripping surface 252. This contact in combination with the force 290 cause the terminating leg portion 250 to torque about a contemplated or hypothetical axis of rotation 292 substantially in direction 294. While some force is required to insert the secondary sign 246 into the secondary sign clip 244, because of the configuration of the secondary sign clip 244, the terminating leg portion 250 is allowed to swing in direction 294 to the displaced position of terminating leg portion 250′ illustrated in dashed lines, therefore widening the insertion mouth 271 and allowing the secondary sign 246 to enter the gripping surface receiving cavity 273 as illustrated as reference number 246′ and in dashed lines.

FIG. 17 illustrates one process of removing a secondary sign 246 from one embodiment of the secondary sign clip 244. Here a downward pulling force 296 is applied to the secondary sign 246. This causes the upper portion of the secondary sign 246 to engage gripping surface 252 and particularly the top edge 275 of the gripping surface 252 or the ribs thereof in a frictional interaction. As the secondary sign 246 engages the gripping surface 250, it pulls the gripping surface 252 substantially in the exaggerated direction 298, toward the front surface 248, to the secondary pulling location of the terminating leg portion. This means that as the secondary sign 246 is pulled, the secondary sign 246 causes the gripping surface 252 to pinch down harder in the direction of the front surface 248, pinching the secondary sign 246 even more firmly in place and resisting removal of the secondary sign 246.

Thus, based on the configuration of the secondary sign clip 244, the gripping surface 252 can be rotated or otherwise displaced away from the front surface 248 during insertion to allow the secondary sign access to the gripping surface receiving cavity 273, but during removal when a pulling force 296 is applied to the secondary sign 246 it engages and rotates or otherwise displaces the gripping surface 252 in the direction 298 toward the front surface 248 such that insertion is easy but removal is relatively more difficult. Further, the sign 246 is increasingly wedged into engagement with sign engagement projections 251, 253.

This interaction is present in all embodiments of the present invention utilizing the double hinge arrangement, the sign engagement projections 251, 253, acting as force concentrators, amplifying and concentrating the secondary sign's 246 interaction with the gripping surface 252. The sign engagement projections 251, 253, axially offset from the gripping surface 252, provide a force in the opposite direction of the force provided by the gripping surface 252, and because of the axial offset, a bending moment and/or torque is applied to a secondary sign 246. Applying such a bending moment is accomplished in one embodiment by the sign engagement projections 251, 253.

While this further embodiment is illustrated with ribs projecting from the terminating leg portion 250, it will be understood by one having ordinary skill in the art that because of the configuration of sign engagement projections 251, 253 being axially offset along the first axis 295 from the gripping surface 252, it would be possible for the terminating leg portion 250 to comprise merely a single rib, which by providing a force axially offset from the force provided in the opposite direction by the sign engagement projections 251, 253 would still apply a bending moment and/or torque on the secondary sign 246, as in an embodiment with multiple ribs projecting from the terminating leg portion 250 and forming the gripping surface 252.

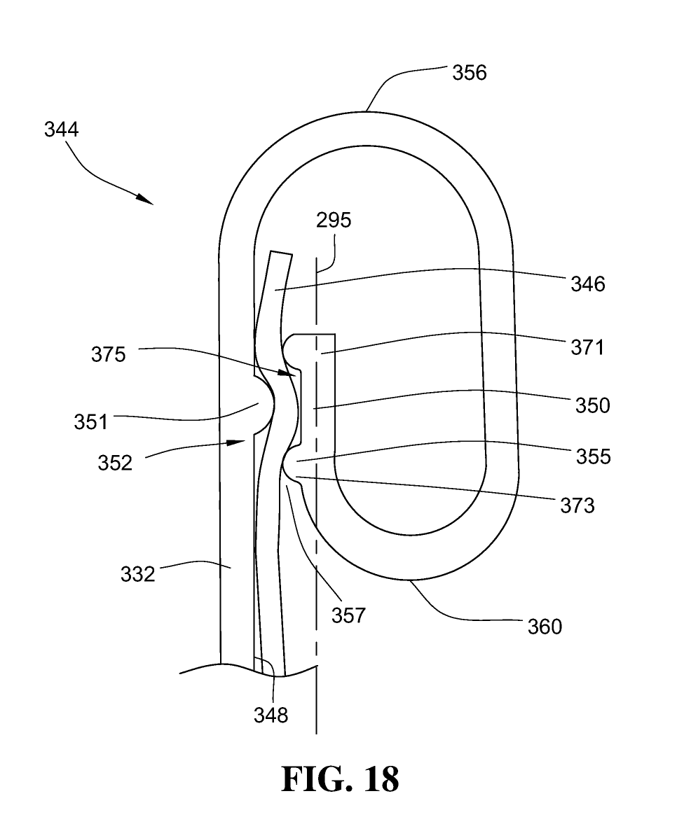

FIG. 18 illustrates another alternate embodiment of the present invention. A single sign engagement projection 351 is defined in the front surface 348 of the front panel 332. A secondary sign clip 344 is again attached to the front panel 332 by a first integral hinge 356. The first integral hinge 356 is connected to the top of the front panel 332 and extends forwardly therefrom to form a generally U-shaped top portion of the secondary sign clip 344. In the illustrated embodiment, the secondary sign clip 344 also includes a second integral hinge 360 between the first integral hinge 356 and the terminating leg portion 350. This second integral hinge 360 forms a generally U-shaped lower portion of the secondary sign clip 344. The terminating leg portion 350 extends vertically upward from the second integral hinge 360 and terminates in a free end. As such, the second integral hinge 360 forms the bottommost portion of the secondary sign clip 244. The terminating leg portion 350 includes a gripping surface 352 defined on the side of the terminating leg portion 350 proximate the front surface 348 of the front panel 332.

Defined in the gripping surface 352 are a first leg sign engagement projection 371 and a second leg sign engagement projection 373. The first leg sign engagement projection 371 is spaced apart an axial distance along first axis 295 from the second leg sign engagement projection 373 along the terminating leg portion. Similar to the sign engagement projections 251, 253 of the previous embodiment, these leg sign engagement projections 371, 373 project outwardly from a base portion 355 coupled to the terminating leg portion 350 to a distal free end 357. The first and second leg sign engagement projections 371, 373 define between them an engagement projection receiving cavity 375 that spans the axial distance along first axis 295 between the first and second leg sign engagement projections 371, 373.

When the secondary sign clip 344 is in a normal state, the first and second leg sign engagement projections 371, 373 are located proximate to or in contact with the front surface 348 and may be biased toward the front surface 348 by the first and second integral hinges 356, 360. The sign engagement projection 351 is received into the engagement projection receiving cavity 375. As in the previous embodiment, when a secondary sign 346 is inserted into the secondary sign clip 344, the secondary sign 346 slides easily into the secondary sign clip 344 because the biasing force towards the front panel 332 provided by the first and second integral hinges 356, 360 is least when the first and second leg sign engagement projections 371, 373 are touching or proximate to the front surface 348. As the secondary sign 346 enters the secondary sign clip 344, it forces the terminating leg portion 350 away from the front surface 348, thereby compressing the second integral hinge 360 and expanding the first integral hinge 356 and therefore increasing the biasing force exerted by the first and second integral hinges 356, 360 towards the front surface 348.

Also, as the secondary sign 346 is inserted into the secondary sign clip 344, the sign engagement projection 351 forces the secondary sign 346 into the engagement projection receiving cavity 375. In doing so, the sign engagement projection 351 deforms the secondary sign 346 which, if one tried to remove the secondary sign 346, would result in an interference interaction between the secondary sign 346, the first leg sign engagement projection 371, the sign engagement projection 351, and the second leg sign engagement projection 373, holding the sign more securely within the secondary sign clip 344. Thus, as in the previous embodiments, the secondary sign 346 is easily slid into the secondary sign clip 344, however once the secondary sign 346 is within the secondary sign clip 344 it is firmly retained within the secondary sign clip 344.

As the previous paragraphs demonstrate, the present invention performs several beneficial functions. The sign clip provides an additional means for holding label or signs for providing additional or temporary information about displayed product. The sign clip may act as a handle for biasing the front panel of the label holder in a forward direction such that removal of labels displayed behind and protected by the front panel of the label holder is made easier. A further aspect of the present invention is that the components of the label holder may be extruded from like material reducing the number of extrusion screw heads required during manufacture.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A label holder for a retail display apparatus, the label holder comprising:
a front panel of a plastic material having a front surface, the front surface including at least one sign engagement projection projecting outward from a base portion toward a distal free end thereof;
a clip integrally connected to the front panel via at least one first integral hinge and pivoting relative to the front panel through the first integral hinge, the clip having a gripping surface facing the front panel, the gripping surface being axially offset from the sign engagement projection, wherein the clip and front panel consist of a single material of a constant hardness characteristic; and
a mount structure connected to the front panel adapted to mount the front panel to the retail display apparatus, the front surface facing away from the mount structure.

2. The label holder of claim 1, wherein the at least one sign engagement projection laterally overlaps with the gripping surface, in a relaxed state, such that the distal end of the at least one sign engagement projection is farther away from the front surface than at least part of the gripping surface in the relaxed state.

3. The label holder of claim 2, wherein the at least one sign engagement projection includes a pair of axially spaced apart sign engagement projections forming a gripping surface receiving cavity therebetween, the gripping surface being laterally received into the receiving cavity in the relaxed state, the gripping surface being laterally positioned between the front surface and distal portion of each of the axially spaced apart sign engagement projections.

4. The label holder of claim 3, further including a label interposed between the front panel and the gripping surface, the label having a rigidity characteristic such that a portion of the label that is axially positioned between the distal free ends of the pair of sign engagement projections is biased into the gripping surface receiving cavity under the loading provided by the spring force generated by the at least one first integral hinge.

5. The label holder of claim 3, wherein the clip has a second integral hinge disposed between the first integral hinge and a leg portion extending upwardly from the second integral hinge toward the first integral hinge, the leg portion including the gripping surface facing the front panel.

6. The label holder of claim 1, wherein the gripping surface of the clip further comprises at least two leg sign engagement projections, wherein the leg sign engagement projections are axially offset from the at least one sign engagement projection of the front surface, the two leg sign engagement projections forming a cavity therebetween that receives therein the at least one sign engagement projection.

7. The label holder of claim 5, wherein the second integral hinge and the at least one sign engagement projection define an insertion mouth configured between the second integral hinge and the at least one sign engagement projection.

8. The label holder of claim 1, wherein the gripping surface includes at least one projection.

9. The label holder of claim 7, wherein:
wherein the at least one sign engagement projection includes a first and a second sign gripping projection;
the clip is configured such that when a force is imparted to the sign to remove the sign from between the front surface and the gripping surface of the clip, the gripping surface engages the sign such that a free end of the gripping surface rotates toward the front panel to reduce a distance therebetween and to increase engagement between the clip and the sign;
the clip is further configured such that when a force is imparted to the sign to insert the sign into the clip, the sign engages the gripping surface forcing the free end of the gripping surface away from the front panel to increase the distance between the front panel and the gripping surface to provide for easier insertion than removal;
the gripping surface is axially offset from the first and second sign gripping projections;
the first and second sign gripping projections and gripping surface define a sign engagement arrangement,
the first sign gripping projection positioned to apply a first biasing force to a sign at a first axial location in a first direction, and the second sign gripping projection being positioned to apply a second force in a second axial location, offset from the first axial location, in a second direction opposite the first direction, the first and second directions are substantially perpendicular to the front surface, when the sign is interposed between the first and second sign gripping projections, such that a bending torque is imparted on a portion of the sign by the first and second sign gripping projections,
the sign gripping projections are substantially semi-circular in shape and have a radius between about 0.3 millimeters and 0.4 millimeters, wherein the sign gripping projections are axially spaced apart substantially between about 3.00 millimeters and 4.00 millimeters, and wherein an outermost tip of a sign gripping projections is located substantially between about 0.2 millimeters and 0.3 millimeters from the second integral hinge.

10. A label holder for a retail display apparatus, the label holder comprising:
a front panel of a plastic material having a front surface;
a clip integrally connected to the front panel via at least one first integral hinge and pivoting relative to the front panel through the first integral hinge;
a sign engagement arrangement formed by a gripping surface of the clip and the front surface for holding a secondary sign therebetween, the sign engagement arrangement having:
a first sign gripping projection positioned to apply a first biasing force to a sign at a first axial location in a first direction, and
a second sign gripping projection being positioned to apply a second force in a second axial location, offset from the first axial location, in a second direction opposite the first direction, when the sign is interposed between the first and second sign gripping projections, such that a bending torque is imparted on a portion of the sign by the first and second sign gripping projections.

11. The label holder of claim 10, wherein the first and second directions are substantially perpendicular to the front surface.

12. The label holder of claim 10, wherein the clip and the front panel consist of a single material of a constant hardness characteristic.

13. The label holder of claim 10, wherein the first and second sign gripping projections are substantially semi-circular in shape.

14. The label holder of claim 13, wherein the first and second sign gripping projections have a radius substantially between about 0.3 millimeters and 0.4 millimeters, wherein the sign clip further comprises a second integral hinge, and wherein the sign gripping projections are axially spaced apart substantially between about 3.00 millimeters and 4.00 millimeters, and wherein an outermost tip of a sign gripping projections is located substantially between about 0.2 millimeters and 0.3 millimeters from the second integral hinge.

15. A label holder for a retail display apparatus, the label holder configured to engage at least one sign, the label holder comprising:
a front panel of a plastic material having a front surface;
a clip integrally connected to the front panel via a first integral hinge and pivoting relative to the front panel through the first integral hinge, the clip including a second integral hinge, the first integral hinge between the second integral hinge and the front panel;
a sign engagement arrangement formed between the clip and the front surface, the clip having a gripping surface;
wherein the clip is configured such that when a force is imparted to the sign to remove the sign from between the front surface and the gripping surface of the clip, the gripping surface engages the sign such that a free end of the gripping surface rotates toward the front panel to reduce a distance therebetween and to increase engagement between the clip and the sign.

16. The label holder of claim 15, wherein the clip is further configured such that when a force is imparted to the sign to insert the sign into the clip, the sign engages the gripping surface engages the sign forcing the free end of the gripping surface away from the front panel to increase the distance between the front panel and the gripping surface to provide for easier insertion than removal.

17. The label holder of claim 16, wherein the front panel further comprises at least one sign engagement projection, and wherein the gripping surface is axially offset from the at least one sign engagement projection.

18. The label holder of claim 17, wherein the at least one sign engagement projection is configured to impart a first force on the sign, wherein the gripping surface is configured to impart a second force on the sign in an opposite direction of the first force imparted by the at least one sign engagement projection, and wherein the first force and the second force are axially offset such that a torque is applied on the sign.
